(19) United States
(12) Patent Application Publication
(10) Pub. No.: US 2007/0118885 A1
(43) Pub. Date: May 24, 2007

(54) Unique SNiP for use in secure data networking and identity management

(76) Inventor: Craig Thomas Elrod, Santa Clara, CA (US)

Correspondence Address: Mr. Craig Thomas Elrod, #305, 2250 Monroe Street, Santa Clara, CA, 95050, US

(21) Appl. No.: 11/284,959

(22) Filed: Nov. 23, 2005

(51) Int. Cl. H04L 9/32

(52) U.S. Cl. 726/5

(57) ABSTRACT

A Process, Method of extracting the unique SNiP portion of DNA then using that unique SNiP to formulate a unique SNiP key and/or unique SNiP data, and using that key and/or data as input into Cryptography Systems, Data Encryption/Decryption, Data Transmission Model, then converting that binary data to a Network address for use in Identity Management, Biometric Encryption, Data Network Security, Digital Certificates, Wired and/or Wireless Data Communications and Identification, Authentication, Authorization, Accounting, Auditing, Encryption, Integrity Checking, IPv4, IPv6, Ethernet, Wired and Wireless data transmission, RFID, RFID location tracking, GPS location and tracking systems, National and/or Global Identification of organisms especially human, living or non-living, mobile or stationary, Ethernet, Identity Based Networking, Identity Tracking, Government National Id, x.400, x.500, x.509, Directory Services, LDAP, Database(s), AAA, TACACS+, Data Storage, Storage Area Networking, conversions and translations between directory services; DNA to provide encryption for data, and tie ownership of that secure data, packets and data streams to an individual human, non-human, living or non-living, mobile or stationary.

### BACKGROUND

The use of biometrics as a means of identification is not a new concept. Law officials have for a long time been using fingerprints as a form of identification. A few other types of biometric identification methods being developed are face, fingerprint, hand geometry, finger geometry, handwriting, vein, voice, eye iris, and eye retina information.

### BRIEF SUMMARY OF INVENTION

Biometrics:

Title of Invention: unique SNiP for use in secure data networking and identity management. This invention applies to the use of security in data networking and identity management on a local as well as a global scale. This invention applies to biometric technology in the use of human DNA or a subset of human DNA, referred to as the SNIP or SNiP, which is a unique identifier of each persons DNA. This invention applies to Authentication, Authorization, Accounting, Auditing, Encryption, Decryption, Integrity Computation, Wired and Wireless data networking, RFID, GPS, IPv4, IPv6, Ethernet, data networking, identity management, identity tracking, government national id, digital certificates, x.500, x.509. The key benefit is to provide encryption for data, and tie ownership of that secure data, packets and data streams to an individual human, or otherwise non-human, living or non-living, mobile or stationary. In other words, you could identify your packets on a network, because they have your SNiP fingerprint in them. Also, the SNiP fingerprint would be useful for identity management, and identity tracking. In an age of a movement toward more computer networking integration throughout the world, the threat and reality of identity theft and other digitally based cyber crimes is frightening. Use of biometrics information for stronger encryption and identity management is needed to increase security, reduce costs and prevent crime.

Encryption:

Traditional computing devices and networking have evolved to the point where some protection has been offered through the form of firewalls, intrusion detection and prevention appliances, and some various forms of encryption known as cryptography.

Problems with Prior Art:

Where there is opportunity, there is a criminal. Cyber criminals have found ways to hack into computers and computer networks to steal valuable information and steal money for their own illegal benefit and gain. Traditional forms of criminal identification such as fingerprinting and retina scanning don't stop or keep criminals from performing these activities. Traditional forms of encryption are too easily hackable, or penetrable by smart cyber criminals that “spoof” or guess they're way into illegal networks.

The problem with current encryption technologies is they can be hacked.

The solution or remedy that the human genome brings is that is cannot be hacked or re-produced. It either exists, or it is no longer a living organism. Within the human DNA is a stand of more identifiable data known as a Single Nucleac Polypeptide chain (SNiP) of DNA which is unique to an individual human being, that no other human being can contain within their body. It is this SNiP that can be used as a unique identifier in the encryption of data in modem networking, both wired and wireless.

The problem with prior art trying to use DNA in data networking, is that there was no uniqueness identified with the use of DNA. This invention uses the unique portion of DNA, that is, the SNiP.

### BRIEF DESCRIPTION OF VIEWS OF DRAWINGS

Disclosure Document Number # 555112

Disclosure Document Number # 555113

Drawing #1: A diagram of the SNiP key derivation function.

Drawing #2: A diagram of the use of the SNiP key for use in data networking.

Drawing #3: A diagram of the SNiP key verification function.

### DETAILED DESCRIPTION

SINGLE NUCLEOTIDE POLYMORPHISM (SNIP): the difference in a single nucleotide between the DNA of individual organisms. What makes one organism's genes different from another's is a change in their DNA structure. That is a change in one DNA base pair out of hundreds that make up a gene. These base pair variations are known as SNiPs—Single Nucleotide Polymorphisms.

Biometric encryption makes standard encryption of data, that use passwords, PIN's, tokens and key cards, obsolete by replacing them with a biometric key derived from the use of a SNiP. This invention makes traditional biometric encryption, such as fingerprint readers, retina scanners, hand geometry scanners, obsolete by replacing it with a biometric key derived from the use of a SNiP.

The SNiP biometric key is derived from the SNiP portion of an organism's DNA, which is unique to the organism, whether it is human, non-human, living, non-living, in motion or stationary. This especially applies to the case of human beings who own their identity, and the information they share with others.

There are Three SNiP Key Processes:

SNiP Key Process #1—Derive the Unique SNiP portion of DNA from an organisms DNA to generate a SNiP Fingerprint. (Drawing #1).
SNiP Key Process #2—Use the Unique SNiP Fingerprint to generate a unique key, and enter it into the data transmission model. (Drawing #2).
SNiP Key Process #3—Verify the key, and create a new unique key if necessary. (Drawing #3).
   SNiP Key Process #1 (Drawing #1):

A process to generate a unique SNiP portion of DNA. Existing art exists, and is known as Comparative Genomics Research (CGR), or a method designed to deliver a “Genome-Wide” dataset of SNiPs for human and other living organisms. This CGR method can be used to generate a unique SNiP portion of DNA.
1. A DNA Sample is taken.
2. A SNiP is derived from the DNA sample.
3. DNA sample is compared to CGR methods.
4. Unique SNiP is produced.

The output of such a process would be the derivation of a SNiP from DNA sample, a human living organism, unique to that individual, not reproduceable or useable by any other living human organism. The SNiP may also be derived from a non-living organism, human, non-human, mobile or stationary.

SNiP Key Process #2 (Drawing #2): Key Derivation and Data Transmission Model:

Unique to this Patent and Invention:

It is this “unique SNiP” portion of the individual organisms DNA that can be used as a “SNiP Fingerprint”.

The result of this process of deriving SNIP data from an organisms DNA produces what we will call a “SNiP Fingerprint”, that is unique to that individual organism, human or otherwise, living or non-living. This invention makes use of the SNiP Fingerprint, for the unique identification of human beings, or other organisms, living or non-living.

Once we have the “SNiP Fingerprint”, we can then enter it into the key derivation and data transmission model for the encryption of data, network security, IPv4, IPv6, Ethernet, Wired and Wireless data transmission, including RFID, GPS, Authentication, Authorization, Accounting, Auditing, Encryption, Decryption, Integrity Computation, Wired and Wireless data networking, IPv4, IPv6, Ethernet, data networking, identity management, identity tracking, government national id, digital certificates, x.500, x.509.

This is a method of extracting the unique SNiP portion of DNA then using that unique SNiP to formulate a unique SNiP key and/or unique SNiP data, and using that key and/or data as input into Cryptography Systems, Data Encryption/Decryption, Data Transmission Model, then converting that binary data to a Network address for use in Identity Management, Biometric Encryption, Data Network Security, Digital Certificates, Wired and/or Wireless Data Communications and Identification, Authentication, Authorization, Accounting, Auditing, Encryption, Integrity Checking, IPv4, IPv6, Ethernet, Wired and Wireless data transmission, RFID, RFID location tracking, GPS location and tracking systems, National and/or Global Identification of organisms especially human, living or non-living, mobile or stationary, Ethernet, Identity Based Networking, Identity Tracking, Government National Id, x.400, x.500, x.509, Directory Services, LDAP, Database(s), AAA, TACACS+, Data Storage, Storage Area Networking, conversions and translations between directory services; DNA to provide encryption for data, and tie ownership of that secure data, packets and data streams to an individual human, or otherwise non-human, living or non-living, mobile or stationary.

This invention uses the unique portion of DNA, that is, the SNiP.

The unique claim of this invention is that SNiP biometric information cannot be spoofed or duplicated, thereby eliminating the possibility of criminal activity and increasing security in all areas of living existence. The individual organism is itself the biometric key, and cannot be hacked or duplicated. If we reach the level of human cloning for criminal activity, then we have another, much larger problem to solve.

The additional benefit to this claim is that the model in which the Key and Data are used are forward-thinking. In other words, the use of hash algorithms and encryption algorithms are left as open systems, such that the latest and strongest hash and encryption algorithms can be used in the model. This keeps the model useable now and into the future, indefinitely, allowing science to stay one step ahead of criminal activity. For example, at the time of this writing, the strongest hash algorithm is known to be SHA-2, and the strongest encryption algorithm is known to be AES-256. Both SHA-2 and AES-256 are publicly available algorithms. As computing power increases and SHA-2 and AES-256 become easily “crackable” or “decryptable”, stronger hash and encryption algorithms may be inserted into this inventions model to maintain it's usefulness and utility.

The new proposed art is a Process, Method of extracting a unique SNiP key, and using that key as input into a data encryption/decryption, data transmission model, then converting that binary data to a Network address for use in Data Communications and Identification, Authentication, Encryption, Integrity Checking, and Identity Management.

The key benefit is to provide encryption for data, and tie ownership of that secure data, packets and data streams to an individual human, or otherwise non-human, living or non-living, mobile or stationary. In other words, you could identify your packets on a network, because they have your SNiP fingerprint in them. Also, the SNiP fingerprint would be useful for identity management, and identity tracking.

SNiP Key Process #3: (Drawing #3):

The method of Using the SNiP biometric data to verify the authenticity of the Key and Data that are used for network security, or any other type of identity management security, for Data Networking for network security, IPv4, IPv6, Ethernet, Wired and Wireless data transmission, RFID. If the authenticity or verification of the Key and Data is confirmed (yes), continue. If the authenticity or verification of the Key and/or Data is invalid then generate a new Key and Data using the SNiP, -and-send “Invalidate Old Key” message along the path as part of the Key and Data transmission to remove the Old Key from the Identity Management and Network Security System.

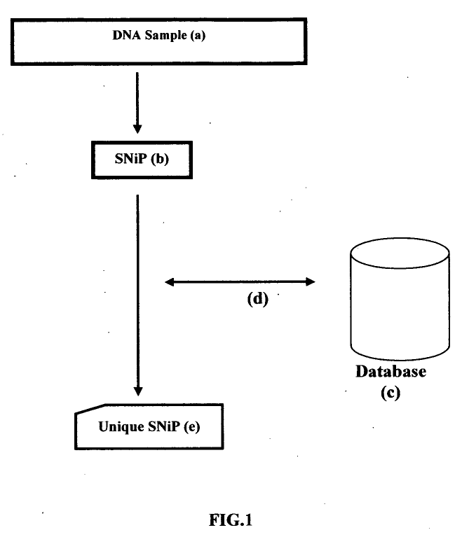

1. A process, method for deriving a Unique SNiP (e) portion of DNA (a) wherein the improvement comprises its use in secure data networking and/or identity management (FIG. 1).

2. the derivation of a SNiP (b) of DNA from an organisms DNA (a).

3. a method to generate a unique SNiP (e) portion of DNA, from SNiP (b), by comparing SNiP (b) to database (c).

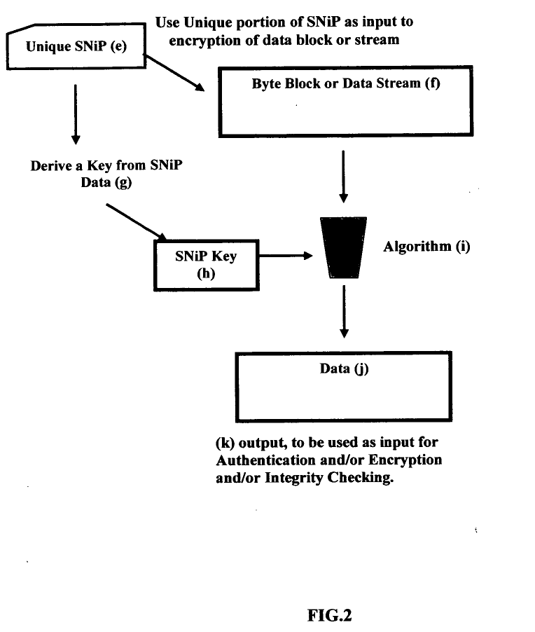

4. A process, method of inputting the unique SNiP (e) data into a process (FIG. 2) wherein the improvement comprises its use for authentication and/or encryption and/or integrity checking.

5. The input of unique SNiP (e) into the encryption function (f) of data, block or stream cipher.

6. The input of unique SNiP (e) into a key generation system (g).

7. The generation of a key (h).

8. The input of the key (h) and/or data (f) into algorithm (i), to produce data output (k).

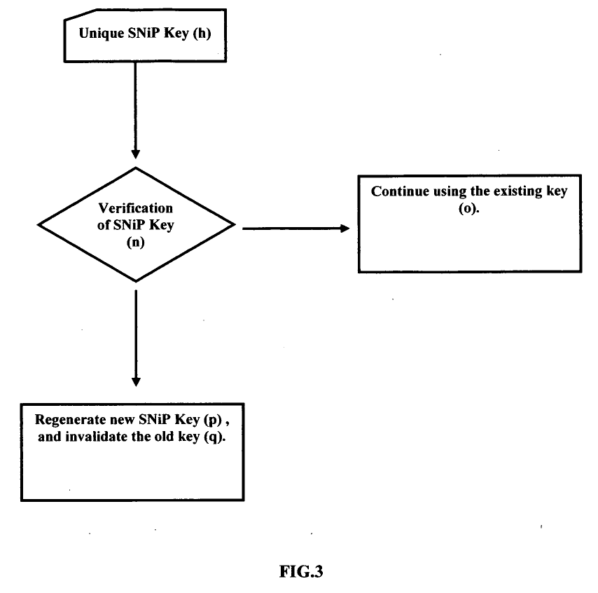

9. A process, method (FIG. 3) for verification of the unique SNiP key (h), and data (k) wherein the improvement comprises its use for verification of use.

10. The input of unique SNiP key (h) into function (n).

11. If verified, continue using (o).

12. If not verified, derive a new key (p), invalidate old key (q).
